(19) United States
(12) Patent Application Publication
(10) Pub. No.: US 2013/0062490 A1
(43) Pub. Date: Mar. 14, 2013

(54) MOUNTING PLATFORM HAVING EXPANDABLE LOCKING MECHANISM, AND METHODS OF MANUFACTURE THEREOF

(71) Applicants: Bryan Godber, San Clemente, CA (US); Eric Anders, Oceanside, CA (US)

(72) Inventors: Bryan Godber, San Clemente, CA (US); Eric Anders, Oceanside, CA (US)

(21) Appl. No.: 13/485,732

(22) Filed: May 31, 2012

Related U.S. Application Data
(60) Provisional application No. 61/532,356, filed on Sep. 8, 2011.

(51) Int. Cl. F16M 13/00

(52) U.S. Cl. 248/298.1; 248/274.1

(57) ABSTRACT

A mounting platform having an expandable locking mechanism for securing the mounting platform relative to one or more surfaces of a mating structure is described. Methods of manufacturing such a mounting platform are also described.

### CROSS-REFERENCE TO RELATED APPLICATIONS

This application claims priority under 35 U.S.C. § 119(e) to co-pending United States Provisional Patent Application Ser. No. 61/532,356, filed Sep. 8, 2011, entitled MOUNTING PLATFORM HAVING EXPANDABLE LOCKING MECHANISM, AND METHODS OF MANUFACTURE THEREOF, the content of which is hereby incorporated by reference herein in its entirety for all purposes.

### FIELD OF THE INVENTION

The present invention relates to mechanisms for securely holding objects, and in particular to mechanisms that frictionally couple to the inside of receptacles, thereby creating a mounting platform for securely holding objects.

### BACKGROUND OF THE INVENTION

Anchoring mechanisms for securely holding objects, including electronic devices, are generally known. On watercraft (e.g., boats, kayaks, etc.) and other sports-related vehicles (e.g., golf carts, ATVs, etc.) or environments, such anchoring mechanisms are typically free standing or merely attach to a portion of the vehicle with a clamp or strap. Unfortunately, these anchoring mechanisms fail to secure objects, such as cameras and the like, in a manner that avoids unwanted detachment of the anchoring mechanism from the portion of the vehicle to which it is attached. As a consequence, such failures can damage the objects.

Moreover, many anchoring mechanisms take up considerable space on space-limited vehicles, causing disruption to a user's enjoyment of the vehicle and the related sporting activity. Many anchoring mechanisms do not compactly disassemble when not in use, taking up valuable storage space and making transport of the anchoring mechanism more difficult.

Furthermore, many anchoring mechanisms are unable to securely carry some objects when the vehicle is vibrating and moving under certain environmental conditions. Anchoring mechanisms that are able to securely hold such objects under such conditions often do so at the expense of prohibiting ease of user access to and maneuverability of the object and the anchoring mechanism.

Additionally, fishing rod holders and other hollow receptacles are generally known; however, mechanisms that insert into the inside of such receptacles are limited in their ability to anchor to the inside of such receptacles. Consequently, such mechanisms do not provide a stable platform for securing objects.

Accordingly, it is desirable to have an anchoring mechanism that easily engages and disengages with various receptacles in various environments (e.g., a fishing rod holder on a boat or kayak). Moreover, it is desirable that such engagement provide a stable platform for carrying heavy loads and for providing maneuverability of the carried load.

### SUMMARY OF THE INVENTION

The present invention provides a mounting platform having an expandable locking mechanism for securing the mounting platform relative to one or more surfaces of a mating structure—e.g., the inner wall(s) of a tube, a pipe, a fishing rod holder, or any other hollow structure having any geometric structure. The locking mechanism is further configured to disengage from the one or more surfaces of the mating structure, thereby releasing the mounting platform.

In accordance with one aspect of the invention, the mounting platform includes a laterally expandable locking mechanism that is substantially aligned along a longitudinal axis of the mounting platform. In certain embodiments, the laterally expandable locking mechanism includes: a screw member substantially aligned with the longitudinal axis, wherein the screw member comprises a first end and a second end; an actuating nut member circumscribing the screw member; a first compressing component oriented substantially parallel with the longitudinal axis and circumscribing the screw member, the first compressing component comprising a first drive surface angled relative to the longitudinal axis, a second drive surface angled relative to the longitudinal axis, and a third drive surface angled relative to the longitudinal axis, wherein rotation of the actuating nut member around the screw member in a first rotational direction causes the first compressing component to move along the longitudinal axis in a first direction, and wherein rotation of the actuating nut member around the screw member in a second rotational direction causes the first compressing component to move along the longitudinal axis in a second direction; a second compressing component positioned opposite the first compressing component on the longitudinal axis and circumscribing the screw member, the second compressing component comprising a fourth drive surface angled relative to the longitudinal axis, a fifth drive surface angled relative to the longitudinal axis, and a sixth drive surface angled relative to the longitudinal axis, wherein the second compressing component couples to the screw member; a first expansion component, wherein the first expansion component comprises an outer contact surface oriented substantially parallel with the longitudinal axis, a first inner drive surface angled relative the longitudinal axis, and a fourth inner drive surface angled relative the longitudinal axis, wherein the first drive surface of the first compressing component is substantially positioned in a cooperating relationship with the first inner drive surface and is slidable there along, and wherein the fourth inner drive surface is substantially positioned in a cooperating relationship with the fourth drive surface of the second compressing component and is slidable there along; a second expansion component, wherein the second expansion component comprises an outer contact surface oriented substantially parallel with the longitudinal axis, a second inner drive surface angled relative the longitudinal axis, and a fifth inner drive surface angled relative the longitudinal axis, wherein the second drive surface of the first compressing component is substantially positioned in a cooperating relationship with the second inner drive surface and is slidable there along, and wherein the fifth inner drive surface is substantially positioned in a cooperating relationship with the fifth drive surface of the second compressing component and is slidable there along; a third expansion component, wherein the third expansion component comprises an outer contact surface oriented substantially parallel with the longitudinal axis, a third inner drive surface angled relative the longitudinal axis, and a sixth inner drive surface angled relative the longitudinal axis, wherein the third drive surface of the first compressing component is substantially positioned in a cooperating relationship with the third inner drive surface and is slidable there along, and wherein the sixth inner drive surface is substantially positioned in a cooperating relationship with the sixth drive surface of the second compressing component and is slidable there along; and a plurality of elastic bands, where the plurality of elastic bands circumscribe the first expansion component, the second expansion component, and the third expansion component, and wherein each of the plurality of elastic bands apply an inward pressure that is perpendicular to the longitudinal axis.

In accordance with yet another aspect of the invention, the screw member may be a threaded bolt with a head at the second end of the screw member. One end of the second compressing component may be configured to contact the head, and the head may be sized to not permit the second compressing component from sliding off of the screw member. Alternatively, an intermediate component (e.g., a washer, a head cover, or other suitable component known in the art) circumscribing the screw member may be disposed between the head and the second compressing component. The intermediate component may be sized to prevent the second compressing component from sliding off the screw member.

In accordance with yet another aspect of the invention, a threaded base component (e.g., a nut, a cap, or other suitable component known in the art) circumscribing the screw member may be coupled to the screw member at the second end of the screw member. The threaded base component may be sized to prevent the second compressing component from sliding off of the screw member. In accordance with this aspect, the second compressing component need not be coupled to the screw member, and may be disposed to freely slide along the longitudinal access of the screw member.

In accordance with yet another aspect of the invention, an intermediate component (e.g., a washer, divider or other suitable component known in the art) circumscribing the screw member may be disposed between the actuating nut member and the first compressing component. The intermediate component may be sized to prevent the first compressing component from sliding off the screw member.

In accordance with yet another aspect of the invention, the first, second and third expansion components may include grooves that receive the elastic bands and hold the elastic bands in place so as to prevent the elastic bands from moving along the outer contact surfaces of the first, second and third expansion components.

In accordance with another aspect of the invention, the mounting platform includes an attachment mechanism for attaching various devices, including picture-taking devices (e.g., cameras, phones, etc.), recreational devices (e.g., fishing poles, boating flags, etc.) and other devices. The attachment mechanism may receive such devices via any means known in the art. For example, such devices may attach to the attachment mechanism via a screw, strap, adhesive component, or quick-release component known in the art. Alternatively, such devices may at least partially insert into the attachment mechanism. The attachment mechanism may be configured to adjust in terms of planar rotation and at orientations angled away from that plane of rotation. For example, the attachment mechanism may include any attachment device known in the art.

### BRIEF DESCRIPTION OF THE DRAWINGS

The present application may be more fully appreciated in connection with the following detailed description taken in conjunction with the accompanying drawings, wherein:

FIG. 1A depicts an assembled mounting platform in accordance with the invention;

FIG. 1A depicts a disassembled mounting platform in accordance with the invention;

FIG. 2 depicts components of an expandable locking mechanism in accordance with the invention;

FIG. 3 depicts a cross-sectional view of components in an expandable locking mechanism in accordance with the invention; and

FIG. 4 depicts an assembled mounting platform that is inserted into a cavity of a mating receptacle in accordance with the invention.

### DETAILED DESCRIPTION OF EMBODIMENTS

Various aspects of the invention are described below. It should be apparent that the teachings herein may be embodied in a wide variety of forms and that any specific structure, function, or both being disclosed herein is merely representative. One skilled in the art should appreciate that an aspect disclosed herein may be implemented independently of any other aspects and that two or more of these aspects may be combined in various ways. For example, an apparatus may be implemented using any number of the aspects set forth herein, and such an apparatus may be implemented using other structure and/or functionality in addition to or other than one or more of the aspects set forth herein.

Reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members.

As previously stated, the present invention provides a mounting platform having an expandable locking mechanism for securing and disengaging the mounting platform relative to one or more surfaces of a mating structure. The mating structure may be any geometric structure with one or more internal surfaces. In accordance with one embodiment, the mating structure is a fishing rod holder. However, one of skill in the art will appreciate that alternative mating structures are within the scope and spirit of the present invention.

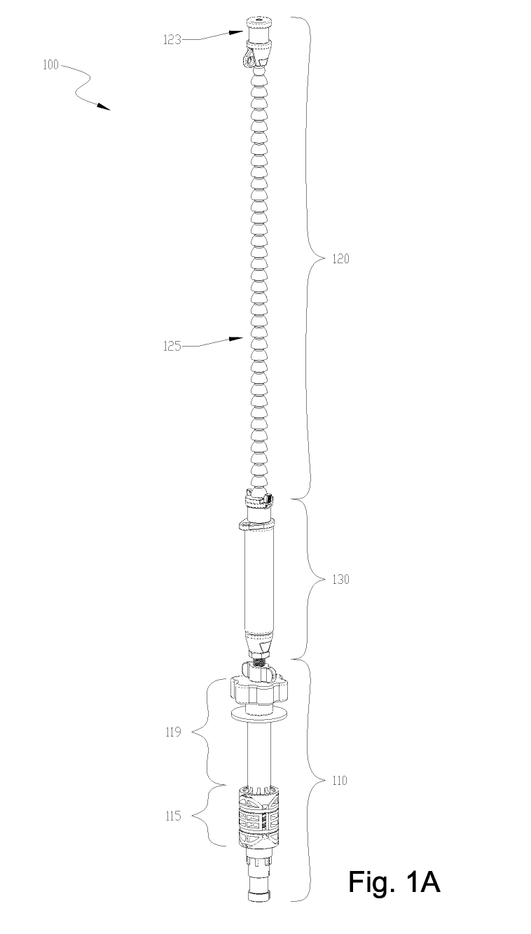

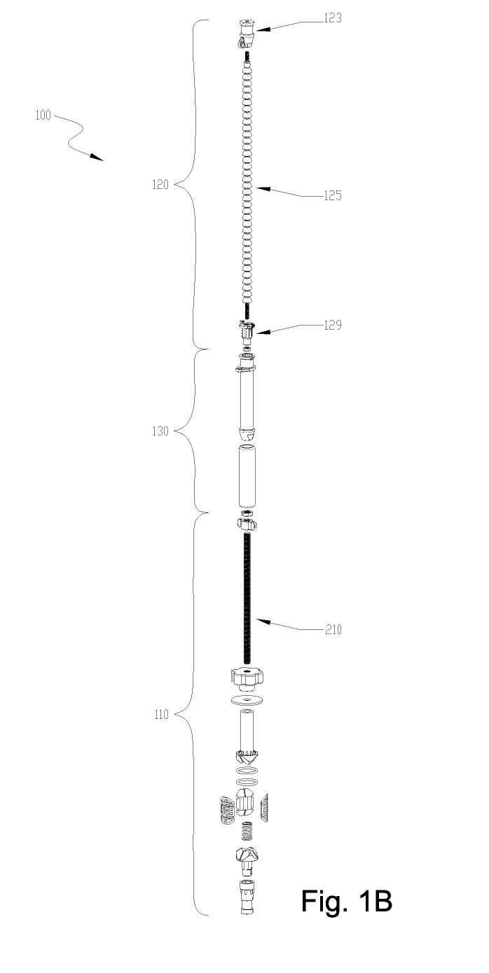

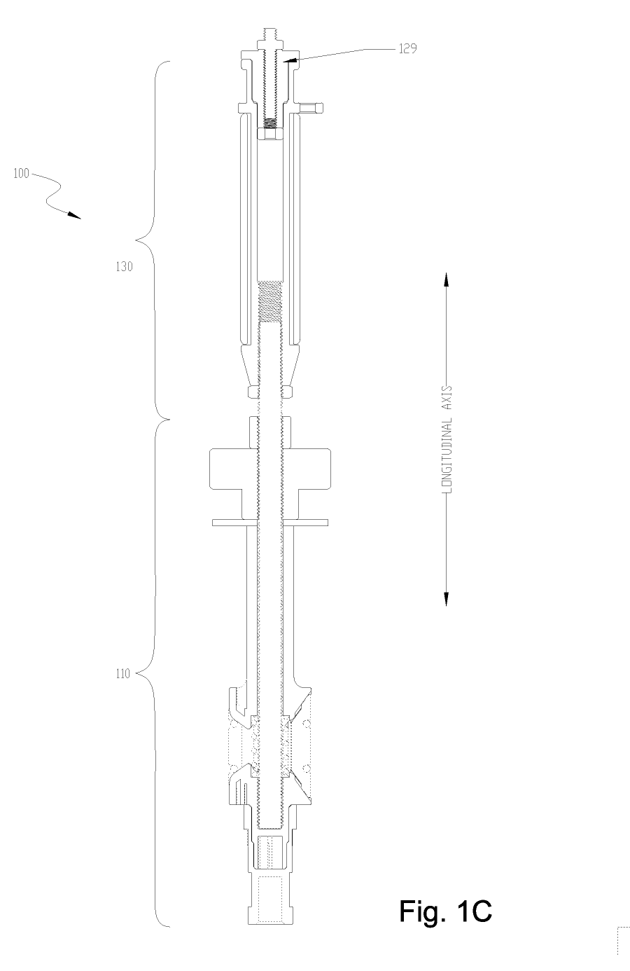

Attention is now drawn to FIGS. 1A, 1B and 1C, which depict a mounting platform (100). FIG. 1A depicts the mounting platform (100) when assembled, FIG. 1B depicts the mounting platform (100) when disassembled, and FIG. 1C depicts a cross-sectional view of the assembled mounting platform (100).

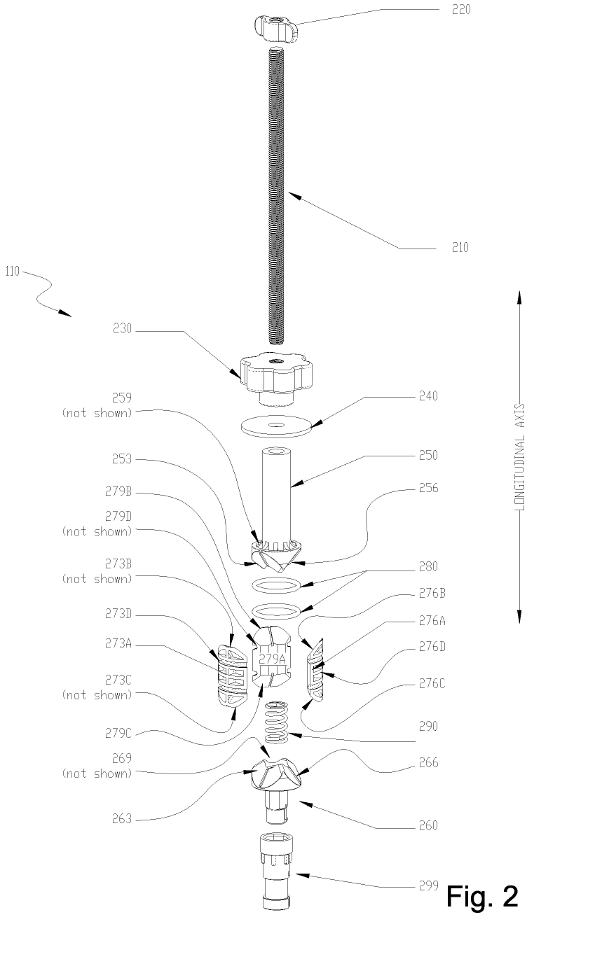

The mounting platform (100) includes an expandable locking mechanism (110), which comprises a plurality of components that are described in further detail below in association with FIG. 2. In particular, the expandable locking mechanism (110) includes an expansion portion (115) and an actuating portion (119). The actuating portion (119) operates on the expansion portion (115) to expand components of the expansion portion (not labeled) outward and away from each other. The expansion of these components compresses outer surfaces of these components against one or more surfaces of the mating structure, thereby creating a friction lock between the components and the mating structure.

The mounting platform (100) further includes an attachment mechanism (120) for securing a device. The device may be any type of device, including a device with a camera. The attachment mechanism (120) may comprise an attachment component (123) and a movement component (125).

The attachment component (123) couples to the device via any of various attachment means known in the art. For example, the device and attachment component (123) may couple via a strap, an adhesion component, a screw, a quick-release component, a friction lock or other attachment means. The movement component (125) may include any suitable component for adjusting the position of the device in terms of planar rotation and angled orientation. For example, the movement component (125) may include a jointed, bendable arm as shown in FIGS. 1A & 1B.

The mounting platform (100) further includes a handle (130) disposed between the attachment component (123) and the expandable locking mechanism (110). As shown in FIG. 1B, the handle (130) couples to a screw member (210) of the expandable locking mechanism (110) and a coupling component (129) of the attachment component (123). The handle (130) may include a plurality of components as shown, or may be formed as one component. The handle (130) may include a fitting (e.g., a quick release fitting) that is positioned to receive or otherwise connect with various camera mounting attachments known in the art. The handle (130) may further include a foam sleeve/grip that slides over a injection-molded body.

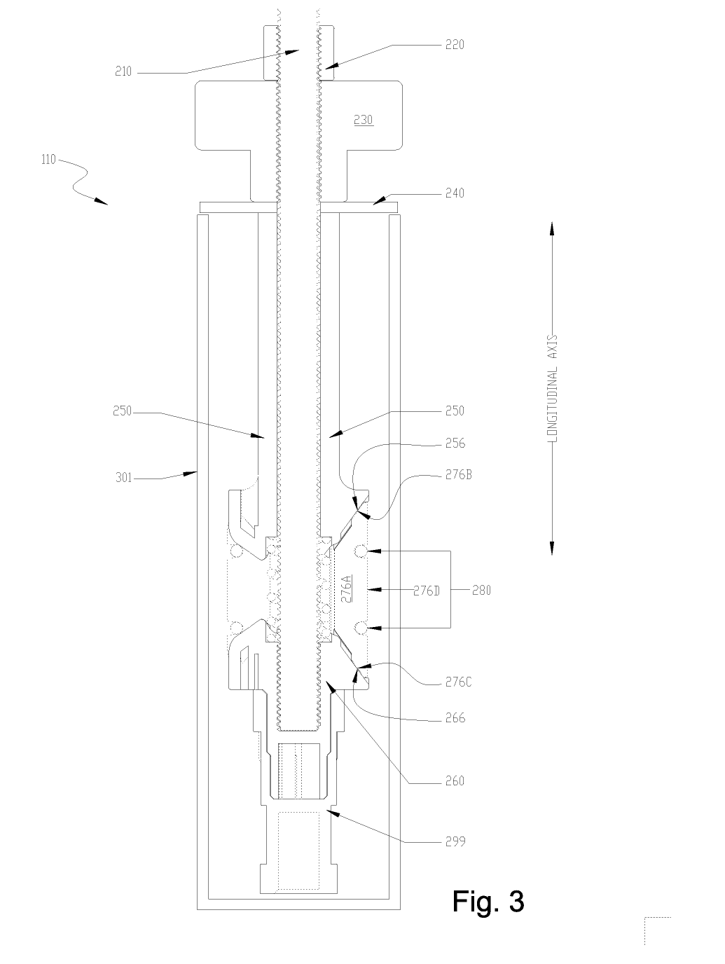

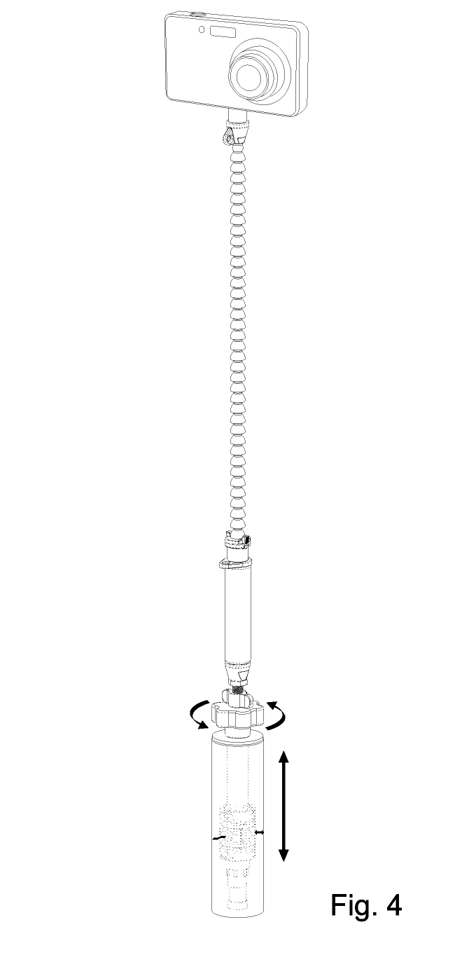

Attention is now drawn to FIG. 2, which depicts the various components of the expandable locking mechanism (110). Reference is also made to FIG. 3, which depicts a cross-sectional view of certain components that form part of the expandable locking mechanism (110). FIG. 3 also depicts an external receptacle (301) (e.g., a tube) into which a portion of the expandable locking mechanism (110) fits.

As shown in FIG. 2, the expandable locking mechanism (110) includes a screw member (210) that is substantially aligned with the longitudinal axis as indicated. The screw member (210) comprises a first end (215) and a second end (219), and can have any latitudinal diameter. In accordance with at least one embodiment, the screw member (210) may be inserted through the center of various components described in further detail below. In other words the various components described in further detail below circumscribe the screw member (210). Some of the components may circumscribe the screw member (210) without engaging its threading, and other components may circumscribe the screw member (210) by engaging its threading. To carry out the latter circumscription, the other components may include complementary threading that mates with the threading of the screw member (210) to form a secure connection between the screw member (210) and the other components.

In accordance with one embodiment not shown in FIG. 2, the screw member (210) may comprise a fixed head at one or more of the first end (215) and the second end (219).

The screw member (210) in this non-illustrated embodiment is more akin to a bolt with threading than a rod with threading which is depicted in FIG. 2. The latitudinal diameter of the fixed head may be sized larger than the latitudinal diameter of the screw member (210) and the latitudinal diameter of other components to prevent those components from sliding off of the inserted screw member (210) at the respective end of the fixed head.

FIG. 2 also depicts a wing nut (220) for circumscribing the screw member (210). The wing nut (220) includes internal threading that mates with the threading of the screw member (210) at or near the first end (215) of the screw member (210) so as to prevent other components circumscribing the screw member (210) from sliding off of the screw member (210).

As shown in FIG. 2, an actuating nut member (230) is disposed to circumscribe the screw member (210). The actuating nut member (230) includes internal threading that mates with the threading of the screw member (210). Depending on the direction of the threading on the screw member (210), rotation of the actuating nut member (230) in clockwise and counterclockwise directions moves the actuating nut member (230) along the longitudinal axis in upward and downward directions.

FIG. 2 further depicts a washer (240) that separates the actuating nut member (230) from a first compressing component (250). The washer (240) is sized with a diameter that is larger than a tube, cylinder or other receptacle into which the expandable locking mechanism (110) is inserted.

As shown in FIG. 2, the first compressing component (250) is oriented substantially parallel with the longitudinal axis. The first compressing component (250) is disposed to circumscribe the screw member (210) without engaging the threading of the screw member (210). In this manner, the first compressing component (250) is disposed to freely move along the longitudinal axis of the screw member (210).

One of skill in the art will appreciate alternative geometry of some or all portions of the first compressing component (250) than those depicted in FIG. 2. However, the geometry of the first compressing component (250) in FIG. 2 is preferred. As shown, the first compressing component (250) is shaped with a three drive surfaces (a first drive surface 253, a second drive surface 256, a third drive surface 259) that are angled relative to the longitudinal axis. As described in more detail below, these three drive surfaces (253, 256, 259) contact and slide along surfaces of other components during certain longitudinal movement of the first compressing component (250).

For example, when the actuating nut member (230) is rotated around the screw member (210) in a first rotational direction, the first compressing component (250) is driven along the longitudinal axis in a first direction (e.g., downward along the longitudinal axis of the screw member (210)). As the first compressing component (250) is driven along the longitudinal axis in the first direction, the three drive surfaces (253, 256, 259) slide along respective upper inner drive surfaces (273B, 276B, 279B) of expansion components (273A, 276A, 279A), which are described in more detail below, or vice versa (i.e., the upper inner drive surfaces (273B, 276B, 279B) of the expansion components (273A, 276A, 279A) slide along the respective three drive surfaces (253, 256, 259) of the first compressing component (250). Similarly, when the actuating nut member (230) is rotated around the screw member (210) in a second rotational direction, the first compressing component (250) is driven along the longitudinal axis in a second direction (e.g., upward along the longitudinal axis of the screw member (210)). As the first compressing component (250) is driven along the longitudinal axis in the second direction, the three drive surfaces (253, 256, 259) slide along the upper inner drive surfaces (273B, 276B, 279B) of the expansion components (273A, 276A, 279A), or vice versa.

FIG. 2 also depicts a second compressing component (260) positioned opposite the first compressing component (250) on the longitudinal axis and circumscribing the screw member. In one embodiment, as depicted in FIG. 2 and FIG. 3, the second compressing component (260) includes internal threading that complimentarily mates with the threading of the screw member (210), thereby coupling the second compressing component (260) to the screw member (210). In a second embodiment, not shown, the second compressing component (260) is not coupled to the screw member, and may be disposed to freely slide along the longitudinal access of the screw member (210) in similar fashion to how the first compressing component (250) may freely slide along the longitudinal access of the screw member (210). In accordance with the second embodiment, the second end (219) of the screw member (210) may include a fixed head (e.g., the head of a threaded bolt) or may be coupled to a nut, each sized to prevent the second compressing component (260) or some intervening component from sliding off of the screw member (210).

One of skill in the art will appreciate alternative geometry of some or all portions of the second compressing component (260) than those depicted in FIG. 2. However, the geometry of the second compressing component (260) in FIG. 2 is preferred. As shown, the second compressing component (260) is shaped with a three drive surfaces (a fourth drive surface 263, a fifth drive surface 265, a sixth drive surface 269) that are angled relative to the longitudinal axis. As described in more detail below, these three drive surfaces (263, 265, 269) complimentarily contact surfaces of other components, which will be described in further detail below, during certain longitudinal movement of the second compressing component (260) (in some embodiments) or those other components (in other embodiments, including the embodiment depicted in FIG. 2).

For example, when the actuating nut member (230) of FIG. 2 is rotated around the screw member (210) in the first and second rotational directions, lower inner drive surfaces (273C, 276C, 279C) of the three expansion components (273A, 276A, 279A), which are described in more detail below, may slide along the respective three drive surfaces (263, 265, 269) of the second compressing component (260).

FIG. 2 also depicts three expansion components (273A, 276A, 279A). A first expansion component (273A) comprises an outer contact surface (273D]) oriented substantially parallel with the longitudinal axis, a first inner drive surface (273B) angled relative the longitudinal axis, and a fourth inner drive surface (273C) angled relative the longitudinal axis. The first inner drive surface (273B) is substantially positioned in a cooperating relationship with the first drive surface (253) of the first compressing component (250), and is slidable there along when the actuating nut member (230) causes the first compressing component (250) to move. Similarly, the fourth inner drive surface (273C) is substantially positioned in a cooperating relationship with the fourth drive surface (263) of the second compressing component (260), and is slidable there along when the actuating nut member (230) causes the first compressing component (250) to move.

The second expansion component (276A) comprises an outer contact surface (276D) oriented substantially parallel with the longitudinal axis, a second inner drive surface (276B) angled relative the longitudinal axis, and a fifth inner drive surface (276C) angled relative the longitudinal axis. The second inner drive surface (276B) is substantially positioned in a cooperating relationship with the second drive surface (256) of the first compressing component (250), and is slidable there along when the actuating nut member (230) causes the first compressing component (250) to move. Similarly, the fifth inner drive surface (276C) is substantially positioned in a cooperating relationship with the fifth drive surface (266) of the second compressing component (260), and is slidable there along when the actuating nut member (230) causes the first compressing component (250) to move.

Similarly, the third expansion component (279A) comprises an outer contact surface (279D) oriented substantially parallel with the longitudinal axis, a third inner drive surface (279B) angled relative the longitudinal axis, and a sixth inner drive surface (279C) angled relative the longitudinal axis. The third inner drive surface (279B) is substantially positioned in a cooperating relationship with the third drive surface (259) of the first compressing component (250), and is slidable there along when the actuating nut member (230) causes the first compressing component (250) to move. Similarly, the sixth inner drive surface (279C) is substantially positioned in a cooperating relationship with the sixth drive surface (269) of the second compressing component (260), and is slidable there along when the actuating nut member (230) causes the first compressing component (250) to move.

FIG. 2 further depicts a plurality of elastic bands (280). Each of the plurality of elastic bands (280) wrap around the outer contact surfaces (273D, 276D, 279D) of the expansion components (273A, 276A, 279A). The elastic bands (280) are disposed to apply an inward pressure, on each the expansion components (273A, 276A, 279A), that is perpendicular to the longitudinal axis.

As shown in FIG. 2, each of the plurality of elastic bands (280) may fit into grooves of the expansion components (273A, 276A, 279A) that hold the elastic bands (280) in place so as to prevent the elastic bands (280) from moving along the outer contact surfaces (273D, 276D, 279D) of the expansion components (273A, 276A, 279A).

A spring (290), as shown in FIG. 2, circumscribes the screw member (210). The spring (290) is positioned between the first compressing component (250) and the second compressing component (260). Movement by the first compressing component (250)—e.g., movement caused by the actuating nut member (230)—towards the second compressing component (260) compresses the spring (290). When not compressed, the spring (290) is designed to maintain a distance between the first compressing component (250) and the second compressing component (260). When compressed, the spring (290) is designed to maintain a smaller distance between the first compressing component (250) and the second compressing component (260).

FIG. 2 also depicts a base component (299) that couples to the second compressing component (260). In one embodiment, the second compressing component (260) couples to the base component (299) by insertion and a snaplock feature. Removal of the second compressing component (260) may occur using a tool (e.g., screwdriver, finger, or other tool known in the art) to depress the snaplock feature, which allows the second compressing component (260) to be removed from the base component (299). The base component (299) may be used for mounting the mounting platform 100 onto an external mounting platform (e.g., Scotty® “quick Release” pole mounting” product, other pole mounts, screw mounts, and other mounts known in the art).

In certain embodiments, not shown, the base component (299) may comprise a different design and include a threading that complimentarily mates with threading of the screw member (210). In these embodiments, the base component (299) may be a nut or some other suitable component that couples to the screw member (210) and prevents the second compressing component (260), which need not have threading and need not couple to the screw member (210), from sliding off of the screw member (210).

As previously mentioned, rotation of the actuating nut member (230) moves the first compressing component (250) towards the second compressing component (260). This movement of the first compressing component (250) compresses the spring (290), and the first compressing component (250) moves closer to the second compressing component (260). As the first compressing component (250) approaches the second compressing component (260), the inner drive surfaces (273B, 276B, 279B, 273C, 276C, 279C) of the expansion components (273A, 276A, 279A) and the drive surfaces (253, 256, 259, 263, 266, 269) of the first and second compressing components (250, 260) interact with each other. During the movement of the first compressing component (250) along the longitudinal axis of the screw member (210), the second compressing component (260) cannot retreat off of the screw member (210) because the coupling of the second compressing component (260) or base component (299) to the screw member (210) is strong enough to resist the force from the compressed spring (290).

Upon compression of the spring (290) and the approach of the first compressing component (250) towards the second compressing component (260) along the longitudinal axis, the inclined planes of contact between the inner drive surfaces (273B, 276B, 279B, 273C, 276C, 279C) and the drive surfaces (253, 256, 259, 263, 266, 269) push the expansion components (273A, 276A, 279A) laterally outward in a direction that is substantially perpendicular to the longitudinal axis. During expansion of the expansion components (273A, 276A, 279A), each of the elastic bands (280) expand laterally outward, and exert a laterally inward pressure onto each of the expansion components (273A, 276A, 279A), thereby keeping their inner drive surfaces (273B, 276B, 279B, 273C, 276C, 279C) in contact with the drive surfaces (253, 256, 259, 263, 266, 269).

Each of the expansion components (273A, 276A, 279A) expand until their outer contact surfaces (273D, 276D, 279D) come into contact with the external receptacle (301). As more lateral pressure is exerted onto the expansion components (273A, 276A, 279A) from further movement of the first compressing component (250) towards the second compressing component (260), a frictional lock is created between the expansion components (273A, 276A, 279A) and the external receptacle (301), or the elastic bands (280) and the external receptacle (301).

Reverse turning of the actuating nut member (230) reverses the movement of the first compressing component (250) along the longitudinal axis and permits the expansion components (273A, 276A, 279A) to contract away from the external receptacle (301) as the inner drive surfaces (273B, 276B, 279B, 273C, 276C, 279C) and the drive surfaces (253, 256, 259, 263, 266, 269) interact with each other in a manner opposite to the interaction that expanded the expansion components (273A, 276A, 279A).

As one of skill appreciates, some aspects of the invention may relate to an expandable locking mechanism that comprises various features described above and shown in the figures. For example one embodiment of an expandable locking mechanism may comprise a first compression component including a first compression surface angled relative to a longitudinal axis at a first angle from the longitudinal axis; a first expansion component including a first expansion surface angled relative to the longitudinal axis at the first angle from the longitudinal axis, wherein either of the first compression surface and the first expansion surface is configured to slide along the other; and a first elastic component encircling at least the first expansion component, wherein the first elastic component is configured to apply pressure onto the first expansion component so that at least a portion of the first expansion surface is in contact with at least a portion of the first compression surface.

The first compression component may be configured to move along the longitudinal axis in a first direction, and movement of the first compression component along the first direction may cause one of the first compression surface and the first expansion surface to slide along the other thereby causing the first expansion component to move away from the longitudinal axis in a first direction.

The first compression component may be further configured to move along the longitudinal axis in a second direction, and movement of the first compression component along the second direction may causes one of the first compression surface and the first expansion surface to slide along the other thereby causing the first expansion component to move towards the longitudinal axis in a direction opposite the first direction.

The expandable locking mechanism may also or alternatively comprise a screw component substantially aligned with the longitudinal axis; and an actuating component circumscribing the screw component. Rotation of the actuating component around the screw member in a first rotational direction may cause the first compression component to move along the longitudinal axis in the first direction.

The expandable locking mechanism may also or alternatively comprise a second expansion component with a second expansion surface angled relative to the longitudinal axis at a second angle from the longitudinal axis. The first compression component may further include a second compression surface angled relative to a longitudinal axis at the second angle from the longitudinal axis. Either of the second compression surface and the second expansion surface may be configured to slide along the other. The first elastic component ma encircle the second expansion component and may be configured to apply pressure onto the second expansion component so that at least a portion of the second expansion surface is in contact with at least a portion of the second compression surface.

The first compression component may be configured to move along the longitudinal axis in a first direction, and movement of the first compression component along the first direction may causes one of the first compression surface and the first expansion surface to slide along the other thereby causing the first expansion component to move away from the longitudinal axis in a first direction, and may also cause one of the second compression surface and the second expansion surface to slide along the other thereby causing the second expansion component to move away from the longitudinal axis in a second direction.

The expandable locking mechanism may also or alternatively comprise a third expansion component with a third expansion surface angled relative to the longitudinal axis at a third angle from the longitudinal axis. The first compression component may further include a third compression surface angled relative to the longitudinal axis at the third angle. Either of the third compression surface and the third expansion surface may be configured to slide along the other. The first elastic component may encircle the third expansion component and may be configured to apply pressure onto the third expansion component so that at least a portion of the third expansion surface is in contact with at least a portion of the third compression surface. The first compression component may be configured to move along the longitudinal axis in a first direction, and movement of the first compression component along the first direction may cause one of the first compression surface and the first expansion surface to slide along the other thereby causing the first expansion component to move away from the longitudinal axis in a first direction, further cause one of the second compression surface and the second expansion surface to slide along the other thereby causing the second expansion component to move away from the longitudinal axis in a second direction, and further cause one of the third compression surface and the third expansion surface to slide along the other thereby causing the third expansion component to move away from the longitudinal axis in a third direction.

The expandable locking mechanism may also or alternatively comprise a second compression component including a fourth compression surface angled relative to the longitudinal axis at a fourth angle from the longitudinal axis. The first expansion component may further include a fourth expansion surface angled relative to the longitudinal axis at the fourth angle from the longitudinal axis. Either of the fourth compression surface and the fourth expansion surface may be configured to slide along the other.

A second elastic component may encircle at least the first expansion component. The second elastic component may be configured to apply pressure onto the first expansion component so that at least a portion of the fourth expansion surface is in contact with at least a portion of the fourth compression surface.

The expandable locking mechanism may also or alternatively comprise a second expansion component with a second expansion surface angled relative to the longitudinal axis at the second angle from the longitudinal axis and a fifth expansion surface angled relative to the longitudinal axis at the fifth angle from the longitudinal axis. The second compression component may further include a fifth compression surface angled relative to a longitudinal axis at a fifth angle from the longitudinal axis. Either of the second compression surface and the second expansion surface is configured to slide along the other. The first elastic component may encircle the second expansion component and may be configured to apply pressure onto the second expansion component so that at least a portion of the second expansion surface is in contact with at least a portion of the second compression surface. Either of the fifth compression surface and the fifth expansion surface may be configured to slide along the other. The second elastic component may encircle the second expansion component and may be configured to apply pressure onto the second expansion component so that at least a portion of the fifth expansion surface is in contact with at least a portion of the fifth compression surface.

The first compression component may be configured to move along the longitudinal axis in a first direction, and movement of the first compression component along the first direction may cause one of the first compression surface and the first expansion surface to slide along the other and cause one of the fourth compression surface and the fourth expansion surface to slide along the other thereby causing the first expansion component to move away from the longitudinal axis in a first direction. Movement of the first compression component along the first direction may also or alternatively cause one of the second compression surface and the second expansion surface to slide along the other and cause one of the fifth compression surface and the fifth expansion surface to slide along the other thereby causing the second expansion component to move away from the longitudinal axis in a second direction.

The expandable locking mechanism may further comprise a screw component substantially aligned with the longitudinal axis; and an actuating component circumscribing the screw component, wherein rotation of the actuating component around the screw member in a first rotational direction causes the first compression component to move along the longitudinal axis in the first direction.

The laterally expandable locking mechanism may also or alternatively comprise a screw member substantially aligned with the longitudinal axis, wherein the screw member comprises a first end and a second end; an actuating nut member circumscribing the screw member; a first compressing component oriented substantially parallel with the longitudinal axis, the first compressing component comprising a first drive surface angled relative to the longitudinal axis, a second drive surface angled relative to the longitudinal axis, and a third drive surface angled relative to the longitudinal axis, wherein rotation of the actuating nut member around the screw member in a first rotational direction causes the first compressing component to move along the longitudinal axis in a first direction, and wherein rotation of the actuating nut member around the screw member in a second rotational direction causes the first compressing component to move along the longitudinal axis in a second direction; a second compressing component positioned opposite the first compressing component along the longitudinal axis, the second compressing component comprising a fourth drive surface angled relative to the longitudinal axis, a fifth drive surface angled relative to the longitudinal axis, and a sixth drive surface angled relative to the longitudinal axis; a first expansion component, wherein the first expansion component comprises an outer contact surface oriented substantially parallel with the longitudinal axis, a first inner drive surface angled relative the longitudinal axis, and a fourth inner drive surface angled relative the longitudinal axis, wherein the first drive surface of the first compressing component is substantially positioned in a cooperating relationship with the first inner drive surface and is slidable there along, and wherein the fourth drive surface of the second compressing component is substantially positioned in a cooperating relationship with the fourth inner drive surface and is slidable there along; a second expansion component, wherein the second expansion component comprises an outer contact surface oriented substantially parallel with the longitudinal axis, a second inner drive surface angled relative the longitudinal axis, and a fifth inner drive surface angled relative the longitudinal axis, wherein the second drive surface of the first compressing component is substantially positioned in a cooperating relationship with the second inner drive surface and is slidable there along, and wherein the fifth drive surface of the second compressing component is substantially positioned in a cooperating relationship with the fifth inner drive surface and is slidable there along; a third expansion component, wherein the third expansion component comprises an outer contact surface oriented substantially parallel with the longitudinal axis, a third inner drive surface angled relative the longitudinal axis, and a sixth inner drive surface angled relative the longitudinal axis, wherein the third drive surface of the first compressing component is substantially positioned in a cooperating relationship with the third inner drive surface and is slidable there along, and wherein the sixth drive surface of the second compressing component is substantially positioned in a cooperating relationship with the sixth inner drive surface and is slidable there along; and/or one or more elastic bands, where the one or more elastic bands wrap around the outer contact surface of the first expansion component, the outer contact surface of the second expansion component, and the outer contact surface of the third expansion component, and wherein the one or more elastic bands apply a pressure onto the first expansion component so that at least a portion of the first drive surface is in contact with at least a portion of the first inner drive surface, at least a portion of the fourth drive surface is in contact with at least a portion of the fourth inner drive surface, at least a portion of the second drive surface is in contact with at least a portion of the second inner drive surface, at least a portion of the fifth drive surface is in contact with at least a portion of the fifth inner drive surface, at least a portion of the third drive surface is in contact with at least a portion of the third inner drive surface, and at least a portion of the sixth drive surface is in contact with at least a portion of the sixth inner drive surface.

Various components depicted in the figures and described above may be manufactured using injection molding techniques to carry out the aspects of the invention described above. Alternatively, some components may be metal and machined according to the specifications needed to carry out the aspects of the invention described above.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. An expandable locking mechanism, comprising:
a first compression component including a first compression surface angled relative to a longitudinal axis at a first angle from the longitudinal axis;
a first expansion component including a first expansion surface angled relative to the longitudinal axis at the first angle from the longitudinal axis, wherein either of the first compression surface and the first expansion surface is configured to slide along the other; and
a first elastic component encircling at least the first expansion component, wherein the first elastic component is configured to apply pressure onto the first expansion component so that at least a portion of the first expansion surface is in contact with at least a portion of the first compression surface.

2. The expandable locking mechanism of claim 1, wherein the first compression component is configured to move along the longitudinal axis in a first direction, wherein movement of the first compression component along the first direction causes one of the first compression surface and the first expansion surface to slide along the other thereby causing the first expansion component to move away from the longitudinal axis.

3. The expandable locking mechanism of claim 2, wherein the first compression component is further configured to move along the longitudinal axis in a second direction, wherein movement of the first compression component along the second direction causes one of the first compression surface and the first expansion surface to slide along the other thereby causing the first expansion component to move towards the longitudinal axis.

4. The expandable locking mechanism of claim 2, further comprising:
a screw component substantially aligned with the longitudinal axis; and
an actuating component circumscribing the screw component, wherein rotation of the actuating component around the screw member in a first rotational direction causes the first compression component to move along the longitudinal axis in the first direction.

5. The expandable locking mechanism of claim 1, wherein the first compression component further includes a second compression surface angled relative to the longitudinal axis at a second angle from the longitudinal axis, the expandable locking mechanism further comprising:
a second expansion component with a second expansion surface angled relative to the longitudinal axis at the second angle from the longitudinal axis, wherein either of the second compression surface and the second expansion surface is configured to slide along the other, and wherein the first elastic component encircles the second expansion component and is configured to apply pressure onto the second expansion component so that at least a portion of the second expansion surface is in contact with at least a portion of the second compression surface.

6. The expandable locking mechanism of claim 5, wherein the first compression component is configured to move along the longitudinal axis in a first direction, and wherein movement of the first compression component along the first direction causes one of the first compression surface and the first expansion surface to slide along the other thereby causing the first expansion component to move away from the longitudinal axis in a first direction, and further causes one of the second compression surface and the second expansion surface to slide along the other thereby causing the second expansion component to move away from the longitudinal axis in a second direction.

7. The expandable locking mechanism of claim 6, wherein the first compression component further includes a third compression surface angled relative to the longitudinal axis at a third angle from the longitudinal axis, the expandable locking mechanism further comprising:
a third expansion component with a third expansion surface angled relative to the longitudinal axis at the third angle from the longitudinal axis, wherein either of the third compression surface and the third expansion surface is configured to slide along the other, wherein the first elastic component encircles the third expansion component and is configured to apply pressure onto the third expansion component so that at least a portion of the third expansion surface is in contact with at least a portion of the third compression surface, wherein the first compression component is configured to move along the longitudinal axis in a first direction, and wherein movement of the first compression component along the first direction causes one of the first compression surface and the first expansion surface to slide along the other thereby causing the first expansion component to move away from the longitudinal axis in a first direction, further causes one of the second compression surface and the second expansion surface to slide along the other thereby causing the second expansion component to move away from the longitudinal axis in a second direction, and further causes one of the third compression surface and the third expansion surface to slide along the other thereby causing the third expansion component to move away from the longitudinal axis in a third direction.

8. The expandable locking mechanism of claim 1, further comprising:
a second compression component including a fourth compression surface angled relative to the longitudinal axis at a fourth angle from the longitudinal axis, wherein the first expansion component further includes a fourth expansion surface angled relative to the longitudinal axis at the fourth angle from the longitudinal axis, wherein either of the fourth compression surface and the fourth expansion surface is configured to slide along the other; and
a second elastic component encircling at least the first expansion component, wherein the second elastic component is configured to apply pressure onto the first expansion component so that at least a portion of the fourth expansion surface is in contact with at least a portion of the fourth compression surface.

9. The expandable locking mechanism of claim 8, wherein the second compression component further includes a fifth compression surface angled relative to the longitudinal axis at a fifth angle from the longitudinal axis, the expandable locking mechanism further comprising:
a second expansion component with a second expansion surface angled relative to the longitudinal axis at the second angle from the longitudinal axis and a fifth expansion surface angled relative to the longitudinal axis at the fifth angle from the longitudinal axis, wherein either of the second compression surface and the second expansion surface is configured to slide along the other, wherein the first elastic component encircles the second expansion component and is configured to apply pressure onto the second expansion component so that at least a portion of the second expansion surface is in contact with at least a portion of the second compression surface, wherein either of the fifth compression surface and the fifth expansion surface is configured to slide along the other, and wherein the second elastic component encircles the second expansion component and is configured to apply pressure onto the second expansion component so that at least a portion of the fifth expansion surface is in contact with at least a portion of the fifth compression surface.

10. The expandable locking mechanism of claim 9, wherein the first compression component is configured to move along the longitudinal axis in a first direction, wherein movement of the first compression component along the first direction causes one of the first compression surface and the first expansion surface to slide along the other and causes one of the fourth compression surface and the fourth expansion surface to slide along the other thereby causing the first expansion component to move away from the longitudinal axis in a first direction, and wherein movement of the first compression component along the first direction further causes one of the second compression surface and the second expansion surface to slide along the other and causes one of the fifth compression surface and the fifth expansion surface to slide along the other thereby causing the second expansion component to move away from the longitudinal axis in a second direction.

11. The expandable locking mechanism of claim 1, further comprising:
a screw component substantially aligned with the longitudinal axis; and
an actuating component circumscribing the screw component, wherein rotation of the actuating component around the screw member in a first rotational direction causes the first compression component to move along the longitudinal axis in the first direction.

12. A laterally expandable locking mechanism, comprising:
a screw member substantially aligned with the longitudinal axis, wherein the screw member comprises a first end and a second end;
an actuating nut member circumscribing the screw member;
a first compressing component oriented substantially parallel with the longitudinal axis, the first compressing component comprising a first drive surface angled relative to the longitudinal axis, a second drive surface angled relative to the longitudinal axis, and a third drive surface angled relative to the longitudinal axis, wherein rotation of the actuating nut member around the screw member in a first rotational direction causes the first compressing component to move along the longitudinal axis in a first direction, and wherein rotation of the actuating nut member around the screw member in a second rotational direction causes the first compressing component to move along the longitudinal axis in a second direction;
a second compressing component positioned opposite the first compressing component along the longitudinal axis, the second compressing component comprising a fourth drive surface angled relative to the longitudinal axis, a fifth drive surface angled relative to the longitudinal axis, and a sixth drive surface angled relative to the longitudinal axis; and
a first expansion component, wherein the first expansion component comprises an outer contact surface oriented substantially parallel with the longitudinal axis, a first inner drive surface angled relative the longitudinal axis, and a fourth inner drive surface angled relative the longitudinal axis, wherein the first drive surface of the first compressing component is substantially positioned in a cooperating relationship with the first inner drive surface and is slidable there along, and wherein the fourth drive surface of the second compressing component is substantially positioned in a cooperating relationship with the fourth inner drive surface and is slidable there along.

13. The expandable locking mechanism of claim 12, further comprising:
a second expansion component, wherein the second expansion component comprises an outer contact surface oriented substantially parallel with the longitudinal axis, a second inner drive surface angled relative the longitudinal axis, and a fifth inner drive surface angled relative the longitudinal axis, wherein the second drive surface of the first compressing component is substantially positioned in a cooperating relationship with the second inner drive surface and is slidable there along, and wherein the fifth drive surface of the second compressing component is substantially positioned in a cooperating relationship with the fifth inner drive surface and is slidable there along.

14. The expandable locking mechanism of claim 13, further comprising:
a third expansion component, wherein the third expansion component comprises an outer contact surface oriented substantially parallel with the longitudinal axis, a third inner drive surface angled relative the longitudinal axis, and a sixth inner drive surface angled relative the longitudinal axis, wherein the third drive surface of the first compressing component is substantially positioned in a cooperating relationship with the third inner drive surface and is slidable there along, and wherein the sixth drive surface of the second compressing component is substantially positioned in a cooperating relationship with the sixth inner drive surface and is slidable there along.

15. The expandable locking mechanism of claim 14, further comprising:
one or more elastic bands, where the one or more elastic bands wrap around the outer contact surface of the first expansion component, the outer contact surface of the second expansion component, and the outer contact surface of the third expansion component, and wherein the one or more elastic bands apply a pressure onto the first expansion component so that at least a portion of the first drive surface is in contact with at least a portion of the first inner drive surface, at least a portion of the fourth drive surface is in contact with at least a portion of the fourth inner drive surface, at least a portion of the second drive surface is in contact with at least a portion of the second inner drive surface, at least a portion of the fifth drive surface is in contact with at least a portion of the fifth inner drive surface, at least a portion of the third drive surface is in contact with at least a portion of the third inner drive surface, and at least a portion of the sixth drive surface is in contact with at least a portion of the sixth inner drive surface.
